(19) United States
(12) Patent Application Publication
(10) Pub. No.: US 2018/0169569 A1
(43) Pub. Date: Jun. 21, 2018

(54) SYSTEM AND METHOD FOR A CHILLED AMMONIA-BASED CARBON DIOXIDE REMOVAL PROCESS

(71) Applicant: General Electric Technology GmbH, Baden (CH)

(72) Inventor: Sanjay Kumar DUBE, Knoxville, TN (US)

(21) Appl. No.: 15/381,697

(22) Filed: Dec. 16, 2016

(51) Int. Cl. B01D 53/14; B01D 19/00; F28C 1/00

(52) U.S. Cl. CPC B01D 53/1431; B01D 53/1475; B01D 2252/102; B01D 53/1406; F28C 1/003; B01D 19/0068

(57) ABSTRACT

A chilled ammonia-based carbon dioxide removal system is provided. The system includes a direct contact cooler, a carbon dioxide absorber and a water wash station.

### TECHNICAL FIELD

Embodiments of the invention relate generally to technologies for reducing carbon emissions in a flue gas, and more specifically, to a system and method for a chilled ammonia-based carbon dioxide removal process.

### BACKGROUND

In the combustion of a fuel, such as coal, oil, peat, waste, etc. in a combustion plant, such as those associated with boiler systems for providing steam to a power plant, a hot process gas, or flue gas, is generated. Such a flue gas will of contain, among other things, contaminants and pollutants such as carbon dioxide (CO₂), sulfur dioxide (SO₂), hydrogen disulfide (H₂S₂), carbon dioxide (CO₂), and/or carbonyl sulfides (OCS), etc.

A variety of methods and technologies exist in order to remove the pollutants from the flue gases. One method for the removal of carbon dioxide from a post-combustion flue gas is the Chilled Ammonia Process (CAP).

With this process, carbon dioxide is removed from the flue gas by contacting a chilled ammonia ionic solution (or slurry) with the flue gas. For example, the flue gas is brought into countercurrent contact with an absorption solution, for example, a liquid ammonia-based solution or slurry, in an absorber. In the absorber, a contaminant-free, i.e., “lean” gas stream is formed and a contaminant-rich absorbent, i.e., a “rich” solution is formed.

After having absorbed the contaminants, the “rich” solution is sent to be “regenerated”, where heat and pressure are used to separate the absorbent solution from the contaminants in order to create an absorbent solution that can be re-used in the absorber to capture further contaminants.

After having absorbed impurities, the ammonia-based solution is typically regenerated in a regenerator column that facilitates release of the impurities from the ammonia-based solution by countercurrent contacting the ammonia-based solution with steam produced by a power plant turbine system.

Regenerators typically operate at a high internal pressure and require the use of high-pressure steam to sufficiently heat the ammonia-based solution to release the from the ionic solution. Under these conditions, (i.e., high pressure and temperature), nearly all of the absorbed carbon dioxide is released into the gas phase in order to form the CO₂-rich gas stream. One of the highest cost penalties of the absorption-capture type systems is the regenerator. The heat and energy required to release the contaminants from the solution heavily burdens the rest of the plant.

The CO₂-rich gas stream may also comprise a minor portion of gaseous NH₃ (i.e., ammonia slip), which can be condensed and returned to the capture system for used in capturing further CO₂ from the gas stream.

In many CAP systems, however, some of the unabsorbed ammonia in the ammonia-based solution is carried out of the CO₂ absorber by the flue gas, resulting in what is commonly referred to as “ammonia slip.”

Accordingly, many CAP systems recapture slipped ammonia via a water wash station, which transfers the slipped ammonia to an ammoniated washing solution, and an ammonia regenerator column, commonly referred to as an ammonia stripper and which heats the washing solution to break up ammonia-CO₂ bonds to facilitate ammonia regeneration.

Many ammonia strippers, however, are expensive to operate in terms of both capital and operating costs. For example, in some CAP systems, the ammonia stripper may utilize as much as forty to fifty percent of the equivalent heat duty of the CO₂ regenerator. Moreover, it is often very difficult to integrate the ammonia stripper waste heat, produced by a corresponding condenser, with the CO₂ regenerator.

Further, some CAP systems operate in gas fired power plants, known as “CAP on GAS” systems. Low pressure heat, however, which is typically used in ammonia strippers, is often not readily available in CAP on GAS systems. Thus, many CAP on GAS systems wastefully use high pressure heat to power ammonia strippers resulting in significant energy losses in the encompassing power plant.

In an attempt to increase the efficiency of CAP technology, some CAP systems have been designed such that an ammonia stripper is no longer required. Such systems, however, often require significant flue gas duct routing, or a reverse osmosis unit, which usually comes at a high capital cost.

What is needed, therefore, is an improved system and method for a chilled ammonia-based carbon dioxide removal process.

### BRIEF DESCRIPTION

In an embodiment, a chilled ammonia-based carbon dioxide removal system is provided. The system includes a direct contact cooler, a carbon dioxide absorber and a water wash station. The direct contact cooler is configured to receive and cool a flue gas, where the flue gas includes gaseous carbon dioxide. The carbon dioxide absorber is disposed downstream of and fluidly connected to the direct contact cooler so as to absorb the gaseous carbon dioxide from the flue gas via an ammonia-based solution that produces an ammonia slip within the flue gas downstream of the carbon dioxide absorber. The water wash station is disposed downstream of and fluidly connected to the carbon dioxide absorber so as to absorb the ammonia slip from the flue gas via a washing solution that stores the absorbed ammonia slip as molecular ammonia. The direct contact cooler is further fluidly connected to the water wash station so as to recover the molecular ammonia from the washing solution.

In another embodiment, a direct contact cooler for an ammonia-based carbon dioxide removal system is provided. The direct contact cooler includes a body, a first opening, a second opening, and a third opening. The body defines a flow path for cooling a flue gas. The first opening is disposed on the body and receives the flue gas at a first end of the flow path. The second opening is disposed on the body and receives a washing solution such that the washing solution flows into the flow path. The third opening is disposed on the body and allows the flue gas to exit the body at a second end of the flow path. The flue gas strips molecular ammonia out of the washing solution as the flue gas travels along the flow path.

In yet another embodiment, a method for recovering absorbed ammonia from a water wash station in a chilled ammonia-based carbon dioxide removal system is provided. The method includes: receiving a flue gas at a first opening of a direct contact cooler; receiving a washing solution at a second opening of the direct contact cooler from the water wash station; and stripping molecular ammonia out of the washing solution via the flue gas within the direct contact cooler.

### DRAWINGS

The present invention will be better understood from reading the following description of non-limiting embodiments, with reference to the attached drawings, wherein below:

FIG. 1 is a schematic block diagram of a chilled ammonia-based carbon dioxide removal system in accordance with an embodiment of the present invention; and

FIG. 2 is a graphical chart depicting the relationship between the percentages of molecular and ionic ammonia in a solution as a function of temperature and pH.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts, without duplicative description.

As used herein, the terms “substantially,” “generally,” and “about” indicate conditions within reasonably achievable manufacturing and assembly tolerances, relative to ideal desired conditions suitable for achieving the functional purpose of a component or assembly.

The term “real-time,” as used herein, means a level of processing responsiveness that a user senses as sufficiently immediate or that enables the processor to keep up with an external process.

As used herein, “electrically coupled”, “electrically connected” and “electrical communication” mean that the referenced elements are directly or indirectly connected such that an electrical current, or other communication medium, may flow from one to the other. The connection may include a direct conductive connection, i.e., without an intervening capacitive, inductive or active element, an inductive connection, a capacitive connection, and/or any other suitable electrical connection. Intervening components may be present.

As also used herein, the term “fluidly connected” means that the referenced elements are connected such that a fluid (to include a liquid, and/or gas) may flow along a flow path from one to the other.

The term “stream,” as used herein, refers to the sustained movement of a substance, e.g., a gas, solid, liquid and/or plasma, so as to form a flow path.

Accordingly, the terms “upstream” and “downstream,” as used herein, describe the position of the referenced elements with respect to a flow path of a gas, solid, and/or liquid, flowing between and/or near the referenced elements.

As also used herein, the term “heating contact” means that the referenced objects are in proximity of one another such that heat/thermal energy can transfer between them.

Further, the terms “molecular ammonia” and “ionic ammonia” refer to NH₃ and NH₄⁺, respectively.

As also used herein, the terms, “stripping” and “stripped” refer to the process by which an element and/or compound in a gas, that includes additional elements and/or compounds, is physically separated/removed from the gas.

Further, as used herein, the term “sorbent” refers to a substance that has the property of collecting/absorbing/storing molecules of another substance.

Accordingly, the terms “lean” and “poor,” as used herein with respect to sorbents and other substances, describe the state of a sorbent or substance when stripped of, or otherwise lacking, absorbed/stored molecules of another substance. Similarly, the terms “loaded” and “rich,” as used herein with respect to sorbents and other substances, describe the state of a sorbent or substance when containing absorbed/stored molecules of another substance. For example, a “CO₂ loaded” or “CO₂-rich” gas or liquid contains a higher amount of CO₂ than a “CO₂ lean” or “CO₂-poor” gas or liquid.

Additionally, while the embodiments disclosed herein are described with respect to a chilled ammonia-based carbon dioxide removal system and methods thereof, it is to be understood that embodiments of the present invention may be applicable to other systems and/or processes where a sorbent needs to be regenerated.

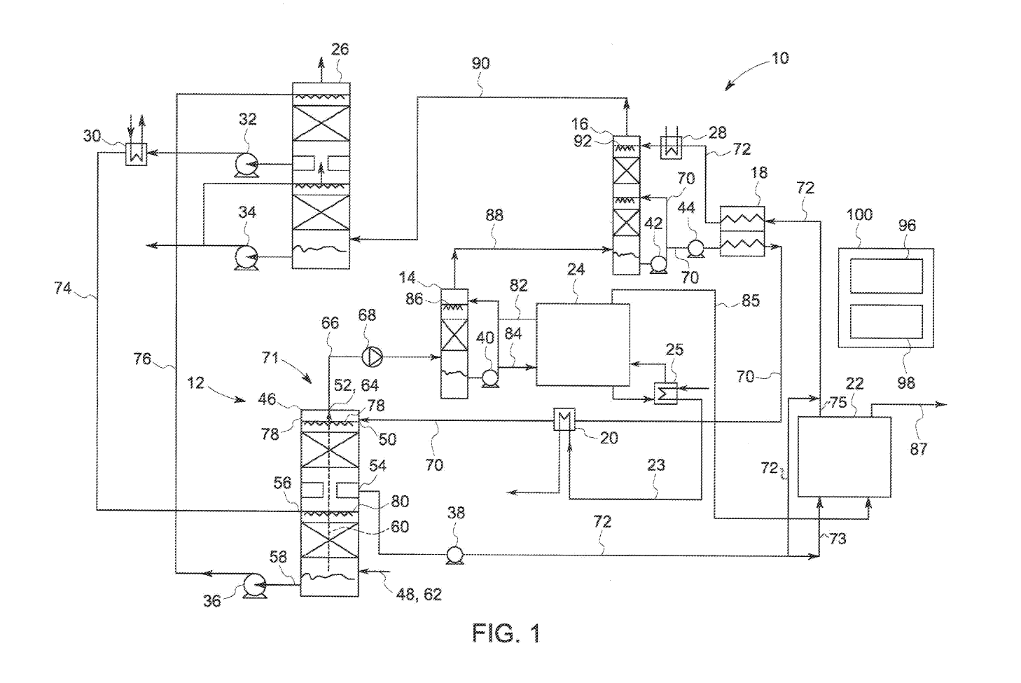

Referring now to FIG. 1, the components of a CAP system 10 that incorporates embodiments of the present invention is shown. The system 10 includes a direct contact cooler (DCC) 12, a CO₂ absorber 14, and water wash station 16. In embodiments, the system 10 may further include a primary heater 18, a secondary heater 20, a CO₂ wash station 22, a regenerator 24, a reboiler 25, a direct contact heater (DCH) 26, a chiller 28, a cooling tower heat exchanger 30 and/or one or more pumps 32-44.

As will be understood, the system 10 may include additional equipment as needed per the requirements of a particular CAP process. Further, as will be described in greater detail below, in embodiments, the primary 18 and secondary heaters 20 are utilized for the recovery of ammonia, as opposed to the recovery of CO2 via the regenerator 24.

The DCC 12 includes a body 46 having a first 48, second 50 and third 52 openings disposed thereon. In embodiments, the body 46 may additionally include a fourth 54, fifth 56 and/or sixth 58 openings disposed thereon.

As shown in FIG. 1, the body 46 defines a flow path 60 for cooling a flue gas (not shown) that includes gaseous CO₂. The first opening 48 receives the flue gas at a first end 62 of the flow path 60 and the third opening 52 allows the flue gas to exit the body 46 at a second end 64 of the flow path 60.

In embodiments, the third opening 52 may be fluidly connected to the CO₂ absorber 14 via conduit 66, which may include a fan 68 that facilitates movement of the flue gas from the DCC 12 to the CO₂ absorber 14.

As also shown in FIG. 1, the second opening 50 may be fluidly connected to the water wash station 16 via conduit 70 so as to receive a washing solution from the water wash station 16. In embodiments, the second opening 50 may be disposed in an upper section 71 of the body 46, i.e., the section of the body 46 that contains the third opening 52.

The fourth opening 54 may be fluidly connected to the CO₂ wash station 22 via conduits 72 and 73 and allows the washing solution to exit the body 46. In embodiments, the DCC 12 may cool the flue gas via a liquid coolant, e.g., water, that absorbs thermal energy from the flue gas. In such embodiments, the fifth 56 and sixth 58 openings may form a heating circuit via conduits 74 and 76 which fluidly connects the DCC 12 to the DCH 26. As is to be appreciated, the DCC 12 may further include spray nozzles 78 and 80 for dispersing the washing solution and the liquid coolant, respectively, into the flow path 60.

The CO₂ absorber 14 is disposed downstream of the DCC 12 and receives the cooled flue gas via conduit 66. In the absorber, a CO₂ lean ammonia-based solution is introduced within the CO₂ absorber 14 via conduit 82 and spray nozzles 86.

The CO₂ lean ammonia-based solution is brought into countercurrent contact with the flue gas to absorb gaseous CO₂ from the flue gas to form a CO₂-lean flue gas and a CO₂-rich ammoniated solution or slurry. In other words, the ammonia-based solution is a sorbent with respect to the CO₂ in the flue gas. The CO₂ absorber 14 is fluidly connected to the regenerator 24 via conduits 82 and 84 so as to form a circulating ammonia-based solution.

The regenerated ammonia-based solution is then cycled back through the CO₂ absorber 14 via conduit 82; and the CO₂-rich gas stream is directed from the regenerator 24 to the CO₂ wash station 22, via conduit 85.

As shown in FIG. 1, the station 22 is disposed along conduit 72 downstream of the DCC 12 and upstream of the primary heater 18 and water wash station 16. Within the CO₂ wash station, the CO₂-rich gas stream may be contacted/washed with a portion, which in embodiments may be a minority portion, of the washing solution diverted from conduit 72 by conduit 73 so as to remove/capture ammonia that may have slipped out of the regenerator 24 via the CO₂-rich gas stream. In other words, the washing solution introduced into the CO2 wash station 22 via conduit 73 “washes” or captures ammonia from the CO₂-rich gas stream exiting the regenerator 24.

In embodiments, the washing solution used to wash the CO₂-rich gas stream within the CO₂ wash station 22 may additionally remove/capture some CO₂ from the CO₂-rich gas stream prior to being returned back to conduit 72 via conduit 75. The washed CO₂-rich gas stream is then transported via conduit 87 to a storage vessel and/or pipeline.

As will be appreciated, some of the ammonia in the ammonia-based solution introduced into the CO₂ absorber 14 via conduit 82 exits with the CO₂ absorber 14 by the flue gas via conduit 88, i.e., the introduction of the ammonia-based solution to the flue gas generates ammonia slip flowing out of the CO₂ absorber 14 via conduit 88. As shown in FIG. 1, the CO₂ absorber 14 is upstream of and fluidly connected to the water wash station 16 via conduit 88. Thus, the ammonia slip from the CO₂ absorber 14 flows with the flue gas to the water wash station 16.

The water wash station 16 is disposed downstream of the CO₂ absorber 14 and upstream of the DCH 26, to which the water wash station 16 is fluidly connected via conduit 90. The flue gas with slipped ammonia enters the water wash station 16 via conduit 88 and travels through the water wash station 16 towards conduit 90. As the flue gas travels through the water wash station 16, the slipped ammonia is absorbed from the flue gas via the washing solution which is introduced into the water wash station 16 via conduit 72 and spray nozzles 92. In embodiments, the ammonia loaded washing solution is sent to the second opening 50 of the DCC 12 via conduit 70 and pumps 42 and/or 44. As will be appreciated, in embodiments, the washing solution may have a temperature between about 5-20° C., a pH between about 6-12, and contain NH₃, NH₄₊, CO₂, HCO₃₋, NH₂COO—, NH₄HCO₃, and/or CO₃². For example, in embodiments, the washing solution may have a temperature of 5° C. and a pH of 10.5 with the following composition: NH₃ 1.05 Kmol/m3; NH₄₊ 0.42 Kmol/m3; NH₂COO— 0.11 Kmol/m3; HCO₃— 0.07 Kmol/m3; and CO₃—2 0.12 Kmol/m3.

The primary heater 18 is disposed along conduit 70 such that the primary heater 18 heats the washing solution prior to being received at the DCC 12 via the second opening 50. In embodiments, the primary heater 18 may be a plate and frame heat exchanger, a cross heat exchanger, or shell and tube heat exchanger. In other embodiments, the primary heater 18 may be a heat exchanger that transfers thermal energy into the washing solution from another heat source. For example, as shown in FIG. 1, the primary heater 18 may be a heat exchanger that transfers thermal energy from conduit 72 to conduit 70, i.e., the primary heater 18 may bring conduits 70 and 72 into heating contact with each other.

The secondary heater 20 may also be disposed within conduit 70 downstream of the primary heater 18. Similar to the primary heater 18, the secondary heater 20 may be a plate and frame heat exchanger, a cross heat exchanger, or shell and tube heat exchanger. In embodiments, the secondary heater 20 may be a heat exchanger that transfers thermal energy from the steam condensate produced in reboiler 25, which is received by the secondary heater 20 via conduit 23, to the washing solution in conduit 70, i.e., the secondary heater 20 may bring conduit 70 into heating contact with the steam condensate from reboiler 25 via conduit 23.

Thus, as will be appreciated, in operation, according to an embodiment, flue gas is received at the first opening 48 of the DCC 12 and enters the body 46 such that the flue gas travels through the body 46 from the first end 62 to the second end 64 of the flow path 60. The flue gas is cooled as it travels through the body 46 by the liquid coolant introduced into the flow path 60 via the fifth opening 56 and spray nozzles 80. The cooled flue gas then flows out of the body 46 via the third opening 52 and into the CO₂ absorber 14 via conduit 66 where it is exposed to the ammonia-based solution via spray nozzles 86.

The ammoniated CO₂-lean flue gas is forwarded via conduit 88 to the water wash station 16 where the ammoniated CO₂-lean flue gas is contacted with the washing solution, via spray nozzles 92, in order to form an ammoniated-lean, CO2-lean flue gas and an ammoniated wash solution. The ammoniated-lean, CO2-lean flue gas is then forwarded to the DCH 26 via conduit 90.

Once within the DCH 26, the ammoniated-lean, CO₂-lean flue gas may be heated by the heating circuit 74, 76, via thermal energy recovered from the liquid coolant and/or the washing solution within the DCC 12, prior to being released into the atmosphere via a stack (not shown).

For example, in embodiments, the liquid coolant may absorb thermal energy from the flue gas and/or the washing solution in the DCC 12, which may then be used to improve the ability of the flue gas leaving the DCH 26 to enter the atmosphere. In embodiments, the DCH 26 may include two stages, wherein residual ammonia from the ammoniated wash solution may be captured in the first stage using an acid wash to form an ammonia salt, e.g., ammonium sulfate, and the flue gas may be reheated in the second stage via the heating circuit 74, 76.

The ammoniated wash solution in the water wash station 16, loaded with the captured ammonia, is sent to the DCC 12 via conduit 70 where it is received at the second opening 50 and flows into the flow path 60 via spray nozzles 78.

In the DCC 12, the ammonia in the ammoniated wash solution is brought into contact with the flue gas entering the DCC where it is then stripped out via the flue gas. As will be understood, molecular ammonia is easier for the flue gas to strip than ionic ammonia. Thus, embodiments of the present invention may utilize the primary 18 and/or secondary 20 heaters to heat the washing solution so as to increase the ratio of molecular ammonia to ionic ammonia within the washing solution. As will also be appreciated, in embodiments, the pH of the washing solution can be adjusted to convert ionic ammonia into molecular ammonia.

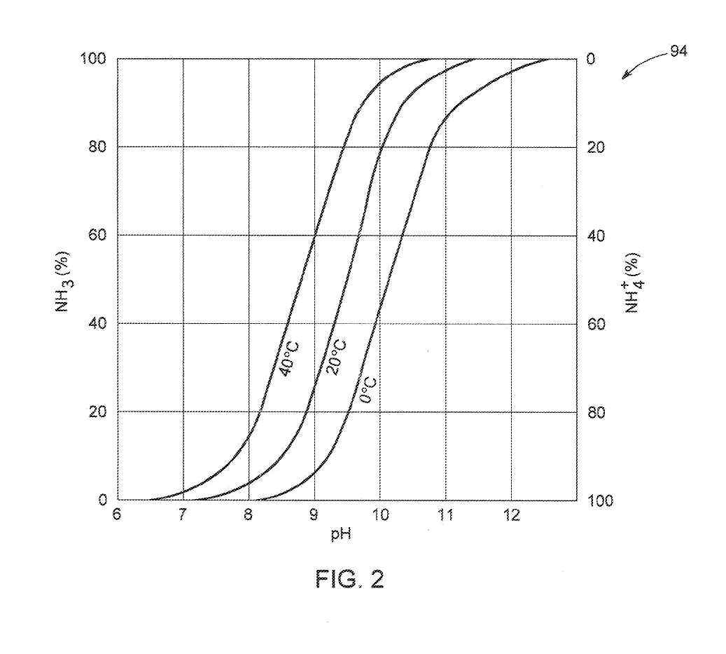

For example, turning now to FIG. 2, a graphical chart 94 depicting the relationship between the percentages of molecular and ionic ammonia in a solution as a function of temperature and pH is shown. As depicted, the ratio of molecular ammonia to ionic ammonia may be increased by increasing the temperature and/or the pH of the solution.

For example, an ammoniated solution having a temperature of 0° C. and a pH of 10 has a molecular ammonia to ionic ammonia ratio of about 1:1.2, i.e., the ammonia in the solution is approximately 45% molecular ammonia and 55% ionic ammonia. Increasing the temperature of the solution to 40° C. while maintaining a pH of 10 changes the molecular ammonia to ionic ammonia ratio to about 9:1, i.e., the ammonia in the solution is approximately 90% molecular ammonia and 10% ionic ammonia.

Referring back to FIG. 1, accordingly, in embodiments, the primary heater 18 may heat/regulate the temperature of the washing solution in conduit 70, which may have a pH between and including 8 and 11 and a temperature between and including 0° C. and 40° C.

As it to be further appreciated, the inclusion of the secondary heater 20 may provide more precision and/or flexibility with respect to controlling/regulating the temperature of the washing solution in conduit 70. As such, in embodiments, the secondary heater 20 may heat/regulate the temperature of the washing solution in conduit 70 to between about 40° C. and 100° C.

For example, in some embodiments, the first 18 and/or the second 20 heaters may heat/regulate the temperature of the washing solution in conduit 70 to between about 40° C. and 50° C. As will be understood, the specified temperature ranges of the washing solution may be achieved by any combination of the primary 18 and secondary 20 heaters. For example, if the primary heater 18 heats the washing solution to 20° C., then the secondary heater 20 may heat the washing solution from 20° C. to the desired temperature, e.g., between about 40° C. and 50° C.

Thus, as is to be appreciated, by heating the washing solution in conduit 70 via the primary 18 and/or secondary 20 heaters, the ratio of molecular ammonia to ionic ammonia is increased. Accordingly, in some embodiments, the ammonia in the washing solution in conduit 70 may be as much as 93% molecular ammonia at 40° C. As stated above, embodiments of the present invention may also adjust the pH of the washing solution in conduit 70 to increase the ratio of molecular ammonia to ionic ammonia. As such, the pH and/or the temperature of the washing solution 70 may be adjusted such that the amount of molecular ammonia in the washing solution is about 100%, for example, at temperatures which may be higher than 40° C.

After being stripped from the washing solution by the flue gas in the body 46 of the DCC 12, the stripped molecular ammonia flows out of the body 46 with the flue gas via the third opening 52 and into the CO₂ absorber 14.

As further shown in FIG. 1, the washing solution, having been stripped of all or most of its formerly captured ammonia, flows out of the DCC 12 via the fourth opening 54 via conduit 72, where, as described above, a portion of the washing solution is diverted into the CO₂ wash station 22 via conduit 73 so as to wash the CO₂ gas stream. As is to be understood, any residual ammonia in the washing solution after leaving the DCC 12 via conduit 72 is likely to be ionic ammonia. As stated above, however, the washing solution used to wash the CO₂ gas stream within the CO₂ wash station 22 may absorb CO₂ from the CO₂ gas stream. Accordingly, washing the CO₂ gas stream with the washing solution helps to ensure that residual molecular ammonia within the washing solution is converted to ionic ammonia so as to reduce and/or prevent ammonia slip from occurring in the water wash station 16. Additionally, in embodiments, washing the CO₂ gas stream with the washing solution may also help to balance the water to ammonia ratio in the CO₂ wash station 22.

Finally, it is also to be understood that the chilled ammonia-based carbon dioxide removal system 10 may include the necessary electronics, software, memory, storage, databases, firmware, logic/state machines, microprocessors, communication links, displays or other visual or audio user interfaces, printing devices, and any other input/output interfaces to perform the functions described herein and/or to achieve the results described herein. For example, the system 10 may include at least one processor 96, and system memory/data storage structures 98 in the form of a controller 100. The memory 98 may include random access memory (RAM) and read-only memory (ROM). The at least one processor 96 may include one or more conventional microprocessors and one or more supplementary co-processors such as math co-processors or the like. The data storage structures discussed herein may include an appropriate combination of magnetic, optical and/or semiconductor memory, and may include, for example, RAM, ROM, flash drive, an optical disc such as a compact disc and/or a hard disk or drive.

Additionally, a software application that provides for control over one or more of the various components of the system 10, e.g., the DCC 12, CO₂ absorber 14, water wash station 16, CO₂ wash station 22, primary heater 18, and/or secondary heater 20, may be read into a main memory of the at least one processor 96 from a computer-readable medium. The term “computer-readable medium,” as used herein, refers to any medium that provides or participates in providing instructions to the at least one processor 96 of the system 10 (or any other processor of a device described herein) for execution. Such a medium may take many forms, including but not limited to, non-volatile media and volatile media.

While in embodiments, the execution of sequences of instructions in the software application causes the at least one processor 96 to perform the methods/processes described herein, hard-wired circuitry may be used in place of, or in combination with, software instructions for implementation of the methods/processes of the present invention. Therefore, embodiments of the present invention are not limited to any specific combination of hardware and/or software.

It is further to be understood that the above description is intended to be illustrative and not restrictive. For example, the above-described embodiments (and/or aspects thereof) may be used in combination with each other. Additionally, many modifications may be made to adapt a particular situation or material to the teachings of the invention without departing from its scope.

For example, in an embodiment, a chilled ammonia-based carbon dioxide removal system is provided. The system includes a direct contact cooler, a carbon dioxide absorber, and a water wash station. The direct contact cooler receives and cools a flue gas that includes gaseous carbon dioxide. The carbon dioxide absorber is disposed downstream of and fluidly connected to the direct contact cooler so as to absorb the gaseous carbon dioxide from the flue gas via an ammonia-based solution that produces an ammonia slip within the flue gas downstream of the carbon dioxide absorber. The water wash station is disposed downstream of and fluidly connected to the carbon dioxide absorber so as to absorb the ammonia slip from the flue gas via a washing solution that stores the absorbed ammonia slip as molecular ammonia. The direct contact cooler is further fluidly connected to the water wash station so as to recover the molecular ammonia from the washing solution. In certain embodiments, the system further includes a primary heater that heats the washing solution prior to recovery of the molecular ammonia by the direct contact cooler. In certain embodiments, the washing solution further stores the absorbed ammonia slip as ionic ammonia, the primary heater heats the washing solution so as to increase a ratio of the molecular ammonia to the ionic ammonia stored within the washing solution, and the direct contact cooler recovers the molecular ammonia from the washing solution by stripping the molecular ammonia out of the washing solution. In certain embodiments, the primary heater heats the washing solution to between about 5° C. and 40° C. In certain embodiments, the system further includes a secondary heater that heats the washing solution prior to recovery of the molecular ammonia by the direct contact cooler. In certain embodiments, the secondary heater heats the washing solution to between about 40° C. and 100° C. In certain embodiments, the system further includes a carbon dioxide wash fluidly connected to the direct contact cooler and to the water wash station so as to receive the washing solution from the direct contact cooler, wash a carbon dioxide gas stream with the washing solution and return the washing solution to the water wash station.

Other embodiments provide for a direct contact cooler for an ammonia-based carbon dioxide removal system. The direct contact cooler includes a body, a first opening, a second opening and a third opening. The body defines a flow path for cooling a flue gas. The first opening is disposed on the body and receives the flue gas at a first end of the flow path. The second opening is disposed on the body and receives a washing solution such that the washing solution flows into the flow path. The third opening is disposed on the body and allows the flue gas to exit the body at a second end of the flow path.

Molecular ammonia is removed from the washing solution as the flue gas travels along the flow path. In certain embodiments, the second opening is for fluidly connecting the body to a water wash station. In certain embodiments, the third opening is for fluidly connecting the body to a carbon dioxide absorber. In certain embodiments, the direct contact cooler further includes a fourth opening disposed on the body for allowing the washing solution to exit the body. In certain embodiments, the fourth opening is for fluidly connecting the body to a carbon dioxide wash. In certain embodiments, the direct contact cooler further includes: a fifth opening and a sixth opening. In such embodiments, the direct contact cooler cools the flue gas via a liquid coolant that absorbs thermal energy from at least one of the flue gas and the washing solution, and the fifth and the sixth openings are for forming a heating circuit to recover the thermal energy from the liquid coolant.

Yet still other embodiments provide for a method for recovering absorbed ammonia from a water wash station in a chilled ammonia-based carbon dioxide removal system. The method includes: receiving a flue gas at a first opening of a direct contact cooler; receiving a washing solution at a second opening of the direct contact cooler from the water wash station; and stripping molecular ammonia out of the washing solution via the flue gas within the direct contact cooler.

In certain embodiments, the method further includes heating the washing solution via a primary heater prior to receiving the washing solution at the second opening of the direct contact cooler. In certain embodiments, the washing solution is heated by the primary heater to between about 5° C. and 40° C.

In certain embodiments, the method further includes heating the washing solution via a secondary heater prior to receiving the washing solution at the second opening of the direct contact cooler. In certain embodiments, the washing solution is heated by the secondary heater to between about 40° C. and 100° C.

In certain embodiments, the method further includes washing a carbon dioxide gas stream with the washing solution via a carbon dioxide wash after stripping the molecular ammonia out of the washing solution via the flue gas within the direct contact cooler.

In certain embodiments, the method further includes returning the washing solution to the water wash station after washing the carbon dioxide gas stream with the washing solution via the carbon dioxide wash.

Accordingly, by utilizing the flue gas within the DCC to strip/recover ammonia captured by the water wash station via the washing solution, some embodiments of the invention provide for a chilled ammonia-based carbon dioxide removal system that does not require an ammonia stripper, and the associated costs.

For example, in some embodiments, the reboiler that heats the CO₂-rich solution or slurry to facilitate regeneration of the ammonia-based solution may be the only component of the CAP system that utilize/consumes steam generated by a boiler. Thus, such embodiments of the present invention may provide for a 40-50% steam savings over existing CAP on GAS systems.

Additionally, because the flue gas in the DCC is used to strip ammonia out of the washing solution, unlike many existing CAP systems, where the liquid to gas ratio (“L/G”) cannot be increased due to an unacceptable corresponding increases in the ammonia stripper energy, some embodiments of the present invention provide for a higher L/G ratio to be used in the water wash station without impacting the ammonia stripper.

While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, terms such as “first,” “second,” “third,” “upper,” “lower,” “bottom,” “top,” etc. are used merely as labels, and are not intended to impose numerical or positional requirements on their objects. Further, the limitations of the following claims are not written in means-plus-function format and are not intended to be interpreted as such, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described invention, without departing from the spirit and scope of the invention herein involved, it is intended that all of the subject matter of the above description shown in the accompanying drawings shall be interpreted merely as examples illustrating the inventive concept herein and shall not be construed as limiting the invention.

What is claimed is:

1. A chilled ammonia-based carbon dioxide removal system comprising:
a direct contact cooler that receives and is configured to cool a flue gas that includes gaseous carbon dioxide;
a carbon dioxide absorber disposed downstream of and fluidly connected to the direct contact cooler configured to absorb the gaseous carbon dioxide from the flue gas via an ammonia-based solution to form a CO₂-rich stream and an ammoniated, CO₂-lean/depleted stream;
a water wash station disposed downstream of and fluidly connected to the carbon dioxide absorber configured to absorb the ammonia slip from the flue gas via a washing solution and form a molecular ammonia stream; and
wherein the direct contact cooler is further fluidly connected to the water wash station and configured to receive the molecular ammonia stream.

2. The system of claim 1 further comprising:
a primary heater that heats the washing solution prior to recovery of the molecular ammonia by the direct contact cooler.

3. The system of claim 2, wherein
the washing solution further stores the absorbed ammonia slip as ionic ammonia,
the primary heater heats the washing solution so as to increase a ratio of the molecular ammonia to the ionic ammonia stored within the washing solution, and
the direct contact cooler recovers the molecular ammonia from the washing solution by stripping the molecular ammonia out of the washing solution.

4. The system of claim 2, wherein the primary heater heats the washing solution to between about 5° C. and 40° C.

5. The system of claim 2 further comprising:
a secondary heater that heats the washing solution prior to recovery of the molecular ammonia by the direct contact cooler.

6. The system of claim 5, wherein the secondary heater heats the washing solution to between about 40° C. and 100° C.

7. The system of claim 1 further comprising:
a carbon dioxide wash station fluidly connected to the direct contact cooler and to the water wash station so as to receive the washing solution from the direct contact cooler, wash a carbon dioxide gas stream with the washing solution, and return the washing solution to the water wash station.

8. A direct contact cooler for an ammonia-based carbon dioxide removal system, the direct contact cooler comprising:
a body defining a flow path for cooling a flue gas;
a first opening disposed on the body for receiving the flue gas at a first end of the flow path;
a second opening disposed on the body for receiving a washing solution such that the washing solution flows into the flow path;
a third opening disposed on the body for allowing the flue gas to exit the body at a second end of the flow path; and
wherein the flue gas strips molecular ammonia out of the washing solution as the flue gas travels along the flow path.

9. The direct contact cooler of claim 8, wherein the second opening is for fluidly connecting the body to a water wash station.

10. The direct contact cooler of claim 8, wherein the third opening is for fluidly connecting the body to a carbon dioxide absorber.

11. The direct contact cooler of claim 8 further comprising:
a fourth opening disposed on the body for allowing the washing solution to exit the body.

12. The direct contact cooler of claim 11, wherein the fourth opening is for fluidly connecting the body to a carbon dioxide wash.

13. The direct contact cooler of claim 8 further comprising:
a fifth opening;
a sixth opening; and
wherein the direct contact cooler cools the flue gas via a liquid coolant that absorbs thermal energy from at least one of the flue gas and the washing solution, and
the fifth and the sixth openings are for forming a heating circuit to recover the thermal energy from the liquid coolant.

14. A method for recovering absorbed ammonia from a water wash station in a chilled ammonia-based carbon dioxide removal system, the method comprising:
receiving a flue gas at a first opening of a direct contact cooler;
receiving a washing solution at a second opening of the direct contact cooler from the water wash station; and
stripping molecular ammonia out of the washing solution via the flue gas within the direct contact cooler.

15. The method of claim 14 further comprising:
heating the washing solution via a primary heater prior to receiving the washing solution at the second opening of the direct contact cooler.

16. The method of claim 15, wherein the washing solution is heated by the primary heater to between about 5° C. and 40° C.

17. The method of claim 15 further comprising:
heating the washing solution via a secondary heater prior to receiving the washing solution at the second opening of the direct contact cooler.

18. The method of claim 17, wherein the washing solution is heated by the secondary heater to between about 40° C. and 100° C.

19. The method of claim 14 further comprising:
washing a carbon dioxide gas stream with the washing solution via a carbon dioxide wash station after stripping the molecular ammonia out of the washing solution via the flue gas within the direct contact cooler.

20. The method of claim 19 further comprising:
returning the washing solution to the water wash station after washing the carbon dioxide gas stream with the washing solution via the carbon dioxide wash station.
